(19) United States
(12) Patent Application Publication
(10) Pub. No.: US 2026/0171309 A1
(43) Pub. Date: Jun. 18, 2026

(54) COMPOSITE PARTICLE AND MULTILAYER CERAMIC CAPACITOR INCLUDING THE SAME

(71) Applicants: SAMSUNG ELECTRO-MECHANICS CO., LTD., Suwon-si (KR); Seoul National University R&DB Foundation, Seoul (KR)

(72) Inventors: Dong Ju Han, Suwon-si (KR); Jeong Ryeol Kim, Suwon-si (KR); Sunho Yoon, Suwon-si (KR); Jeongah Jeong, Suwon-si (KR); Seong-Hyeon Hong, Seoul (KR); Jongwon Lee, Seoul (KR); Doyeon Lee, Seoul (KR)

(73) Assignees: SAMSUNG ELECTRO-MECHANICS CO., LTD., Suwon-si (KR); Seoul National University R&DB Foundation, Seoul (KR)

(21) Appl. No.: 19/291,241

(22) Filed: Aug. 5, 2025

(30) Foreign Application Priority Data
Dec. 16, 2024 (KR) 10-2024-0187118

(51) Int. Cl. H01G 4/008; C04B 35/626; H01G 4/012; H01G 4/12; H01G 4/30

(52) U.S. Cl. CPC H01G 4/008; C04B 35/62655; H01G 4/012; H01G 4/1209; H01G 4/30

(57) ABSTRACT

A composite particle according to an example of the present disclosure includes: a core containing Ni; and a shell that is located on the core and includes a compound containing at least one of Al or Zr, wherein a content of Al or Zr is from 0.001 parts by mole to 5.0 parts by mole based on 100 parts by mole of Ni.

### CROSS-REFERENCE TO RELATED APPLICATION

This application claims priority to and the benefit of Korean Patent Application No. 10-2024-0187118 filed with the Korean Intellectual Property Office on Dec. 16, 2024, the entire contents of which are incorporated herein by reference.

### BACKGROUND OF THE INVENTION

### (a) Field of the Invention

The present disclosure relates to a composite particle and a multi-layered ceramic capacitor including the same.

### (b) Description of the Related Art

A multi-layered ceramic capacitor (MLCC), which is one of a capacitor component, is a chip-shaped condenser mounted on a printed circuit board (PCB) of various electronic products such as an image device such as a liquid crystal display (LCD) and a plasma display panel (PDP), a computer, a smartphone, and a mobile phone to charge or discharge electricity.

Such an MLCC is used as a component in various electronic devices due to its merits of being small, ensuring high capacity, and being easy to mount.

The MLCC may include an internal electrode in a dielectric material ceramic. In addition, an MLCC may be manufactured by laminating a ceramic green sheet containing a conductive paste including an internal electrode material and a ceramic powder by a sheet method or a printing method, and then simultaneously firing the sheets.

Since sintering start temperatures of the internal electrode material and dielectric material ceramic powder are different, shrinkage mismatch between the internal electrode layer and the dielectric material may occur during the sintering of the ceramic green sheet. Accordingly, the stability of the MLCC may be deteriorated and the resistance of the internal electrode may increase during the firing process.

In addition, nickel powder needs be fired under a reduction atmosphere, which may relatively increase process cost and time.

### SUMMARY OF THE INVENTION

According to one aspect of the present disclosure, a composite particle having improved chemical and physical stability can be provided.

According to another aspect of the present disclosure, a cost-effective and time-saving manufacturing method for a composite particle with improved chemical and physical stability can be provided.

According to another aspect of the present disclosure, a multi-layered ceramic capacitor with improved structural stability, reliability, and capacity characteristics can be provided.

However, the tasks that examples of the present disclosure seek to solve are not limited to the tasks described above, and can be expanded in various ways within the range of technical ideas included in the present disclosure.

A composite particle according to an example includes: a core containing Ni; and a shell that is disposed on the core, and includes a compound containing at least one of Al or Zr, wherein the content of Al or Zr is from 0.001 parts by mole to 5.0 parts by mole based on 100 parts by mole of Ni.

The compound may contain at least one selected from a group consisting of an Al oxide and a Zr oxide.

The Al oxide may include an amorphous structure, and the Zr oxide may include a crystalline structure.

The compound may be disposed on at least a part of a surface of the core.

The core may include an Ni nanoparticle.

The core may be defined as a region in which the Ni content is 95 mol % or more among a total amount of elements included in the composite particle. The shell may be defined as a region in which the Ni content is less than 5 mol % among the total amount of elements included in the composite particle and includes Al or Zr.

The composite particle may further include a middle layer that is disposed between the core and the shell, and contains an Ni oxide.

The Ni oxide may contain an NiO.

The middle layer may be defined as a region where the Ni content is 5 mol % or more and less than 95 mol % of the total amount of elements included in the composite particle.

A multi-layered ceramic capacitor according to another example includes: a capacitor body including a dielectric layer and an internal electrode; and an external electrode disposed at an outer side of the capacitor body, wherein the internal electrode layer includes an interface region with the dielectric layer, the interface region of the internal electrode layer contains Ni and at least one of Al or Zr, and the multi-layered ceramic capacitor uses the above-described composite particle.

The interface region of the internal electrode layer may be defined as a region from an interface of the dielectric layer and the internal electrode layer to a depth of 1 μm in the inward direction of the internal electrode layer.

The content of Al or Zr in the interface region of the internal electrode layer may be 0.1 atom percent to 1 atom percent based on 100 atom percent of Ni in the interface region of the internal electrode layer.

Al or Zr may diffuse from the composite particle and exist in the interface region of the internal electrode layer and the dielectric layer.

The content of Al or Zr in the interface region of the internal electrode layer may be greater than the content of Al or Zr in the dielectric layer.

The dielectric layer may include an interface region with the internal electrode layer, the interface region of the dielectric layer may include Ni and at least one of Al or Zr, and the interface region of the dielectric layer may be defined as a region from the interface of the dielectric layer and the internal electrode layer to a depth of 1 μm in the inward direction of the dielectric layer.

The content of Al or Zr in the interface region of the dielectric layer may be 0.1 atom percent to 1 atom percent based on 100 atom percent of Ni in the interface region of the dielectric layer.

A manufacturing method of a composite particle according to another example includes: forming a first solution by injecting at least one selected from a group consisting of an Al precursor and a Zr precursor to a solvent; forming a second solution by injecting Ni power to the first solution; forming a third solution by dispersing the second solution using a sonication method; and obtaining a composite particle by drying the third solution. The composite particle includes a core containing Ni and a shell disposed on the core and including a compound that contains at least one of Al or Zr, and the content of Al or Zr of the composite particle is from 0.001 parts by mole to 5.0 parts by mole based on 100 parts by mole of Ni.

The Al precursor may contain Al chloride and the Zr precursor may contain Zr chloride.

The drying may include applying the third solution on a hot plate and volatilizing the solvent.

According to some example embodiments of the present disclosure, the sintering start temperature of the composite particle can increase when the composite particle includes Al or Zr, which has a relatively higher sintering start temperature than Ni. Accordingly, the difference in sintering/shrinkage start temperature between the electrode containing the composite particle and the dielectric material surrounding the electrode can be alleviated. Therefore, structural damage such as shrinkage imbalance and crack of the electron element including the electrode and the dielectric material can be suppressed.

According to the some example embodiments of the present disclosure, the difference in sintering/shrinkage start temperature between the dielectric layer and the internal electrode layer can be reduced, and shrinkage imbalance can be alleviated, thereby improving the stability and operation reliability of the multi-layered ceramic capacitor.

### BRIEF DESCRIPTION OF THE DRAWINGS

FIG. 1 is a cross-sectional view that conceptually shows a composite particle according to an example.

FIG. 2 is a cross-sectional view that conceptually shows a composite particle according to another example.

FIG. 3 is a flow chart provided for description of a manufacturing method of a composite particle according to an example.

FIG. 4 is a perspective view that conceptually shows a MLCC according to an example.

FIG. 5 is a conceptual cross-sectional view of the MLCC of FIG. 3, taken along the line I-I′.

FIG. 6 is a conceptual cross-sectional view of the MLCC of FIG. 3, taken along the line II-II′.

FIG. 7 shows scanning electron microscope (SEM), SEM-Energy dispersive X-ray spectroscopy (SEM-EDS), and transmission electron microscopy (TEM) analysis images of composite particles according to Example 1.

FIG. 8 shows SEM, SEM-EDS, and TEM analysis images of composite particles according to Example 2.

FIG. 9 shows SEM, SEM-EDS, and TEM analysis images of composite particles according to Comparative Example 1.

FIG. 10 shows an inductively coupled plasma-atomic emission spectroscopy (ICP-AES) analysis result of the composite particle according to Example 1.

FIG. 11 shows an ICP-AES analysis result of the composite particle according to Example 2.

FIG. 12 is a thermomechanical analysis (TMA) graph showing the volume change according to the sintering temperature of the composite particle pellets according to Examples 1 and 2 and Comparative Example 1.

FIG. 13 is a graph that shows a change in density according to the sintering temperature of the composite particle pellets according to Examples 1 and 2 and Comparative Example 1.

FIG. 14 is an X-ray diffraction (XRD) graph of the composite particle pellet according to Examples 1 and 2 and Comparative Example 1.

FIG. 15 shows SEM analysis images of composite particle pellets according to sintering temperatures according to Examples 1 and 2 and Comparative Example 1.

FIG. 16 shows TEM analysis images of the composite particle pellet according to the sintering temperature according to Example 1.

FIG. 17 shows TEM analysis images of the composite particle pellet according to the sintering temperature according to Example 2.

FIG. 18 are scanning transmission electron microscopy-EDS (STEM-EDS) analysis images of the cross-section of the multi-layered ceramic capacitor according to Example 1.

FIG. 19 are STEM-EDS analysis images of the cross-section of the multi-layered ceramic capacitor according to Example 2.

FIG. 20 is SEM analysis images that show the connectivity of the multi-layered ceramic capacitors according to Examples 1 and 2 and Comparative Example 1.

### DETAILED DESCRIPTION OF THE EMBODIMENTS

Hereinafter, with reference to the accompanying drawing, an example is described in detail such that a person of ordinary skill in the art to which the present disclosure belongs can easily carry out the present disclosure. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

The accompanying drawings are provided for helping to easily understand examples disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise,” and variations such as “comprises” or “comprising,” will be understood to imply the inclusion of stated elements but not the exclusion of any other elements.

Further, in the entire specification, when it is referred to as “on a plane,” it means when a target part is viewed from above, and when it is referred to as “on a cross-section,” it means when the cross section obtained by cutting a target part vertically is viewed from the side.

Further, throughout the specification, when it is referred to as “connected,” this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

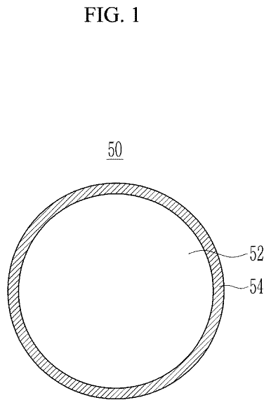

FIG. 1 is a cross-sectional view that conceptually shows a composite particle according to an example. FIG. 1 may show a cross-section cut through a center point of a composite particle 50.

Referring to FIG. 1, a composite particle 50 according to some example embodiments may include a core 52 containing nickel (Ni) and a shell 54 disposed on the core 52.

Nickel (Ni) contained in the core 52 may be in the form of a Ni nanoparticle. Accordingly, the dispersion of the composite particle 50 may be improved. For example, an average particle diameter D50 of the core 52 may be about 50 nm to 100 nm.

The average particle diameter D50 may represent a size (i.e., particle diameter) at a point where the cumulative percentage in the size cumulative distribution becomes 50%. For example, the size cumulative distribution may be obtained by measuring the longest axis of at least 100 cores 52 in the SEM analysis image.

The shell 54 may include a compound containing at least one of aluminum (Al) or zirconium (Zr). In some example embodiments, the shell 54 may contain Al or Zr. In another example embodiments, the shell 54 may include an Al compound or a Zr compound. Since the composite particle 50 contains Al or Zr, which has a relatively higher sintering start temperature than Ni, the sintering start temperature of the composite particle 50 may increase. Accordingly, a difference in sintering start temperatures between an electrode containing the composite particle 50 and a dielectric material around the electrode may be alleviated. Therefore, a structural damage such as shrinkage mismatch and crack of an electron element including the electrode and the dielectric material may be suppressed.

In some embodiments of the present disclosure, internal electrode layers of a multi-layered ceramic capacitor (MLCC) may include a plurality of the composite particles 50.

The content of elements contained in the core 52 and the shell 54 may be measured by performing inductively coupled plasma-atomic emission spectroscopy (ICP-AES) analysis on the composite particles 50. A sample may be prepared by dissolving composite particles 50 of a predetermined weight in acid, decomposing them using a microwave, diluting them with distilled water, and filtering them. The sample may be introduced into an ICP-AES device using a nebulizer. Analysis can be performed while maintaining the plasma state by injecting argon (Ar) gas into the ICP-AES device. Through the analysis, the types and contents of elements contained in the composite particle 50 can be measured.

The compound of the shell 54 may include at least one selected from a group consisting of Al oxide and Zr oxide. For example, the compound may include AlOₓ (0<x<2) or ZrO₂.

The Al oxide (e.g., AlOₓ) may be in an amorphous structure. Accordingly, the Al oxide can surround the surface of the core 52 more uniformly. Therefore, the sintering start temperature of the composite particle 50 may be further increased.

The Zr oxide (e.g., ZrO₂) may be in a crystalline structure. Accordingly, a crystalline particle of the Zr oxide having a size of several tens of nanometers may suppress the grain boundary movement of Ni, thereby further suppressing the sintering of Ni.

The term “shell” as used in this specification may include a structure that continuously and entirely surrounds the surface of the core 52, as well as a structure that is discontinuously disposed over a portion of the surface of the core 52.

The compound of the shell 54 may be disposed on at least a part of the surface of the core 52. For example, the compound may be disposed discontinuously only on some parts of the core 52. For example, the compound may entirely cover the surface of the core 52.

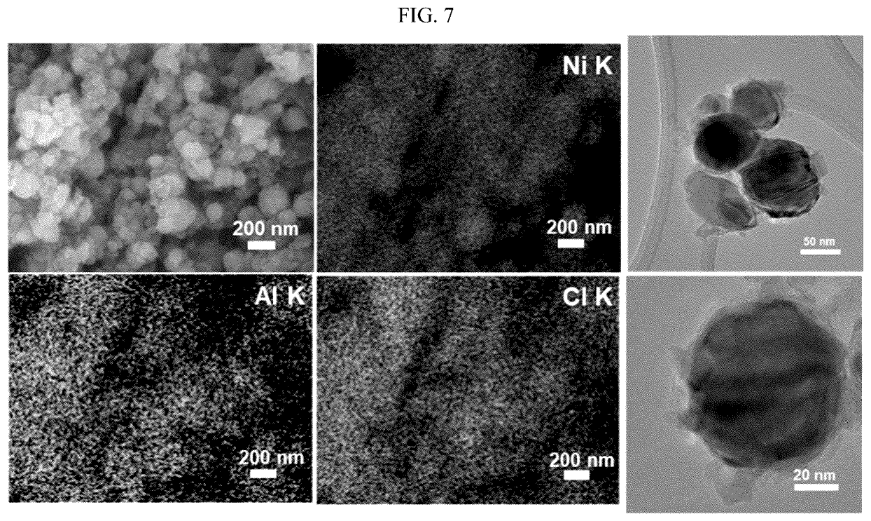

The structure of the composite particle 50 described above can be measured through scanning electron microscope (SEM), scanning electron microscope-energy dispersion-type spectroscopy (SEM-EDS), and transmission electron microscope (TEM) analyses. The composite particles 50 may be compressed to prepare a cylindrical pellet having a diameter of about 0.5 mm and a height of about 2.0 mm to 2.5 mm. SEM and TEM analysis images of cross-sections cut along a height direction through a center point of the cylindrical pellet may be obtained, respectively. The distribution of the core 52 and the shell 54 of the composite particle 50 may appear in the SEM and TEM analysis images. EDS mapping may be performed on the acquired SEM analysis image (SEM-EDS analysis) to confirm the distribution of constituent elements included in the composite particles 50. SEM, SEM-EDS and TEM analyses may be performed at magnifications from 1K to 20K. When observing the TEM analysis image with the naked eye, a region with relatively low brightness may be determined as the core 52, and a region with relatively high brightness may be determined as the shell 54 (refer to FIGS. 7, 8, 16, and 17 described later). The brightness may refer to a brightness level when setting the TEM analysis image to black and white. In addition, a region in which the Ni content is 95 mol % or more among the total amount of elements included in the composite particle 50 may be determined as the core 52, and a region in which the Ni content is less than 5 mol % and includes Al or Zr may be determined as the shell 54 by performing the EDS analysis on the TEM analysis image.

According to some example embodiments, the content of Al or Zr included in the composite particle 50 may be from about 0.001 parts by mole to about 5.0 parts by mole based on 100 parts by mole of Ni. In such a range, the sintering temperature of the composite particle 50 may be sufficiently improved and the chemical stability may be improved. Accordingly, the difference in sintering start temperature between the electrode including the composite particle 50 and the dielectric material around the electrode can be sufficiently alleviated. The total amount may represent the total number of mols.

The shell 54 may contain Al or Zr. In this case, the content of Al per 100 parts by mole of Ni, or the content of Zr per 100 parts by mole of Ni in the composite particle, may be from about 0.001 parts by mole to about 5.000 parts by mole.

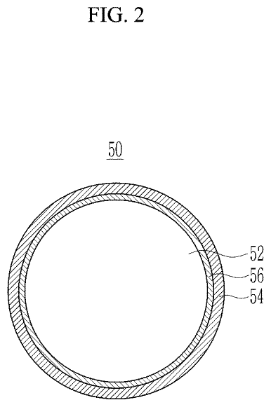

FIG. 2 is a cross-sectional view that conceptually shows a composite particle according to another example. FIG. 2 may show a cross-section cut through a center point of a composite particle 50 according to another example.

Referring to FIG. 2, according to another example, a composite particle 50 may further include a middle layer 56 disposed between a core 52 and a shell 54.

The middle layer 56 may contain a Ni oxide. For example, some of Ni contained in the core 52 may be oxidized to form the middle layer 56 containing the Ni oxide.

The chemical stability of the core 52 may be further improved through the middle layer 56 containing the Ni oxide.

When observing a TEM analysis image with the naked eye, a region with relatively higher brightness than the core 52 and lower brightness than the shell 54 may be determined as the middle layer 56 (refer to FIGS. 7, 8, 16, and 17 described later). In addition, a region in which the Ni content is 5 mol % or more and less than 95 mol % among the total amount of elements included in the composite particle 50 may be determined as the middle layer 56 by performing the EDS analysis on the TEM analysis image.

For example, the Ni oxide may contain NiO.

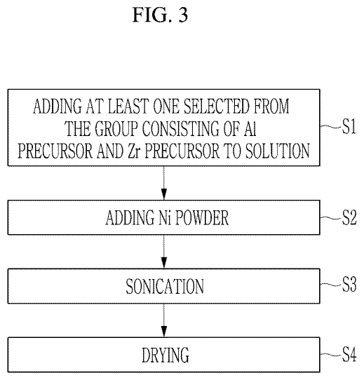

FIG. 3 is a flow chart provided for description of a manufacturing method of a composite particle according to some example embodiments of the present disclosure.

Referring to FIG. 3, a first solution may be formed by injecting at least one selected from the group consisting of an Al precursor and a Zr precursor into a solvent (e.g., S1).

The Al precursor may contain an Al chloride. For example, the Al precursor may contain AlCl₃·6H₂O. The Zr precursor may contain a Zr chloride. For example, the Zr precursor may contain at least one of ZrCl₄ or ZrOCl₂·8H₂O.

By using the chloride described above as the Al precursor and the Zr precursor, the shell 54 may be sufficiently formed on the core 52 containing Ni through a simple process.

The solvent may include an aqueous solvent such as water; an alcohol solvent such as ethanol, methanol, benzylalcohol, methoxyethanol; a glycol solvent such as ethyleneglycol, diethyleneglycol; a ketone solvent such as acetone, methylethylketone, methylisobutylketone, cyclohexanone; an ester solvent such as acetic acidbutyl, acetic acidethyl, carbitolacetate, butylcarbitolacetate; an ether solvent such as methylcellosolve, ethylcellosolve, butylether, tetrahydrofuran; an aromatic solvent such as benzene, toluene, xylene, and the like. For example, an alcohol-based solvent or an aromatic-based solvent may be used, considering the solubility or dispersion of various additives included in the dielectric material slurry. For example, the solvent may be an ethanol solvent.

According to some example embodiments, a second solution may be formed by injecting Ni powder to the first solution (e.g., S2). The Ni powder may include an Ni nanoparticle.

According to an example, the second solution may be dispersed using a sonication (i.e., sonication) method to form a third solution (e.g., S3).

The sonication may be carried out by using a bath sonicator, a probe sonicator, a tip sonicator, and the like.

The shell 54 containing Al or Zr may be more uniformly formed on the core 52 containing Ni by performing the sonication on the second solution including at least one of Ni, Al, or Zr. The term “uniform” as used in this specification does not only refer to mathematically rigorous uniformity, but also includes cases that are considered substantially uniform. The term “substantially” means that the recited characteristic, parameter or value need not be exactly achieved, but rather deviations or variations in the amount that do not interfere with the effect that the characteristic is intended to provide, including, for example, tolerances, measurement error, measurement accuracy limitations and other factors known to those of skill in the art.

According to an example, the third solution may be dried to obtain the composite particle 50 (e.g., S4).

The drying may include applying the third solution to a hot plate and volatilizing the solvent. Accordingly, the process convenience and process cost of the composite particle 50 including the shell 54 containing Al or Zr may be reduced.

A temperature of the hot plate may be about 50° C. to about 200° C. In this range, the solvent is sufficiently volatilized and Al and Zr of the shell 54 may be stably positioned on the core 52.

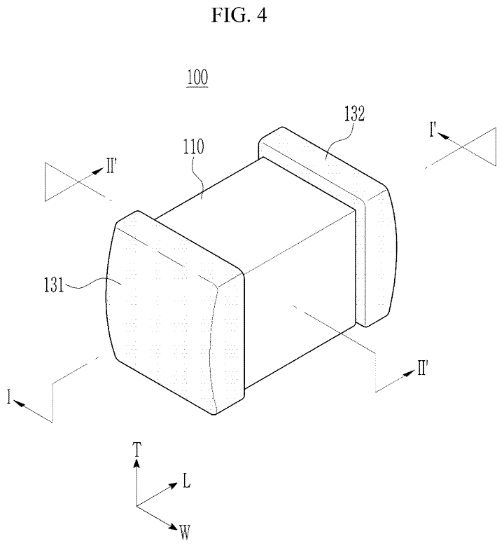

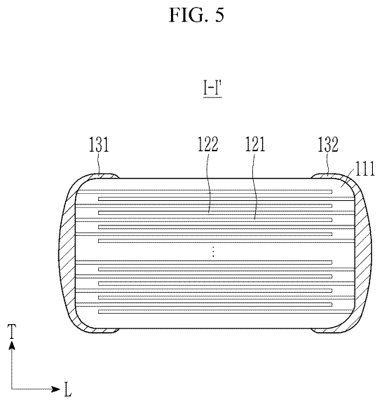

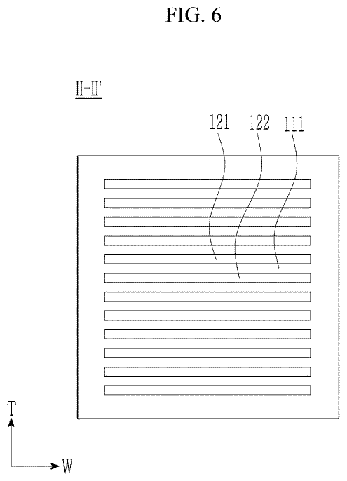

FIG. 4 is a perspective view that conceptually shows an MLCC according to an example. FIG. 5 is a conceptual cross-sectional view of the MLCC of FIG. 3, taken along the line I-I′. FIG. 6 is a conceptual cross-sectional view of the MLCC of FIG. 3, taken along the line II-II′.

Referring to FIG. 4 to FIG. 6, an MLCC 100 may include a capacitor body 110 and external electrodes 131 and 132 disposed outer sides of the capacitor body 110. The external electrodes 131 and 132 may include a first external electrode 131 and a second external electrode 132 disposed at opposite ends of the capacitor body 110, facing each other in a length direction (L-axis direction).

The L-axis, the W-axis, and the T-axis shown in FIG. 4 to FIG. 6 indicate a length direction, a width direction, and a thickness direction of the capacitor body 110, respectively. Here, the thickness direction (T-axis direction) may be a direction perpendicular to a wide surface (main surface) of a sheet-shaped component, and may be used as the same concept as a lamination direction in which, for example, the dielectric layer 111 is laminated. The length direction (L-axis direction) is a direction that extends parallel to the wide surface (main surface) of the sheet-shaped component, and may be a direction that is approximately perpendicular to the thickness direction (T-axis direction), and may be, for example, a direction in which the first external electrode 131 and the second external electrode 132 are positioned on both sides. The width direction (W-axis direction) is a direction that extends parallel to the wide surface (main surface) of the sheet-shaped component, and may be a direction that is approximately perpendicular to the thickness direction (T-axis direction) and the length direction (L-axis direction), and a length of the length direction (L-axis direction) of the sheet-shaped component may be greater than a length of the width direction (W-axis direction).

In one example, the capacitor body 110 may have a roughly hexahedral shape.

Hereinafter, for better comprehension and ease of explanation, two sides facing each other in the thickness direction (T-axis direction) of the capacitor body 110 are defined as a first side and a second side, the two sides connected to the first and second sides and facing each other in the length direction (L-axis direction) are defined as a third side and a fourth side, and two sides connected to the third side and the fourth side and facing each other in the width direction (W-axis direction) are defined as a fifth side and a sixth side.

The first surface, which is s bottom surface of the capacitor body 110, may be a surface facing a mounting direction of the MLCC 100. At least one of the first side to the sixth side may be flat. Alternatively, at least one of the first side to the sixth side may have a convex central portion, and edges that are boundaries of each side may be rounded.

The shape, dimensions and number of stacking of the dielectric layer 111 of the capacitor body 110 are not limited to those shown in the drawing of the present disclosure.

The capacitor body 110 may include a dielectric layer 111 and internal electrodes 121 and 122. The capacitor body 110 may include a plurality of dielectric layers 111.

The capacitor body 110 may include a plurality of dielectric layers 111, and a first internal electrode 121 and a second internal electrode 133 disposed alternately while disposing the dielectric layer 111 therebetween in the thickness direction (T-axis direction).

The boundaries between adjacent dielectric layers 111 may be integrated such that they are difficult to see without using an SEM.

The capacitor body 110 may include an active region. The active region may be a part that contributes to the capacitance formation of the MLCC 100. For example, the active region may be a region where the first internal electrode 121 or the second internal electrode 122, which is laminated along the thickness direction (T-axis direction), overlaps.

The capacitor body 110 may further include a cover region and a side margin region.

The cover region is a margin portion in a thickness direction and may be disposed adjacent to the first and second sides of the active region in the thickness direction (T-axis direction). For example, a single dielectric layer 111 or two or more dielectric layers 111 may be laminated on upper and lower surfaces of the active region, respectively, to serve as the cover region.

The side margin region is a margin portion in a width direction and may be disposed adjacent to the fifth side and sixth side of the active region in the width direction (W-axis direction). The side margin region may be formed by applying a conductive paste layer only to a portion of the dielectric green sheet surface, and laminating and sintering dielectric green sheets without a conductive paste layer on both sides of the dielectric green sheet surface.

For example, damage to the first internal electrode 121 and the second internal electrode 122 due to physical or chemical stress can be prevented through the cover region and the side margin region.

The dielectric layer 111 may contain a barium titanate compound as a primary component. For example, by using the barium titanate compound as a dielectric material base material, the dielectric characteristics of the MLCC 100 may be secured.

The barium titanate compound may include at least one selected from the group consisting of BaTiO₃, BaZrO₃, BaSnO₃, CaTiO₃, CaZrO₃, CaSnO₃, SrTiO₃, SrZrO₃, SrSnO₃, and the like. These can be used alone or in combination of two or more.

The dielectric layer 111 may further include a secondary component. The secondary components may include at least one selected from the group consisting of manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), vanadium (V), and the like. These can be used alone or in combination of two or more.

According to some example embodiments, an average thickness (i.e., average length in the T-axis direction) of the dielectric layer 111 may be about 1.0 μm to about 8.0 μm. According to another example, the average thickness (i.e., average length in the T-axis direction) of the dielectric layer 111 may be about 2 μm to 6 about μm. In these ranges, reliability of the MLCC 100 can be further improved.

The average thickness of the dielectric layer 111 may be measured by performing SEM analysis on a cross-section (L-T cross-section) cut perpendicular to the width direction (W-axis direction) and the length direction (L-axis direction) and the lamination direction (T-axis direction) from the center of the width direction (W-axis direction) of the MLCC 100. In the SEM analysis image, the center point of the dielectric layer 111 in the length direction (L-axis direction) or width direction (W-axis direction) is used as a reference point, and the arithmetic average value of the thickness of the dielectric layer 111 measured at 10 points, which are spaced a predetermined interval from the reference point, may be obtained. The spacing between the 10 points can be adjusted according to the scale of an SEM image, and can be, for example, 1 μm to 100 μm, 1 μm to 50 μm, or 1 μm to 10 μm. In this case, all 10 points needs to be positioned within the dielectric layer 111. If all 10 points are not positioned within the dielectric layer 111, the position of the reference point may be changed or the spacing between the 10 points may be adjusted.

The first internal electrode 121 and the second internal electrode 122 of the internal electrode layers 121 and 122 may have different polarities. For example, the first internal electrode 121 and the second internal electrode 122 may be alternately arranged to face each other along the T-axis direction with the dielectric layer 111 therebetween. For example, one end of the first internal electrode 121 may be exposed through the third side of the capacitor body 110, and one end of the second internal electrode 122 may be exposed through the fourth side of the capacitor body 110.

The first internal electrode 121 and the second internal electrode 122 may be electrically insulated by the dielectric layer 111 disposed therebetween.

An end of the first internal electrode 121 exposed through the third side of the capacitor body 110 may be electrically connected with the first external electrode 131. For example, an end of the second internal electrode 122 exposed through the fourth side of the capacitor body 110 may be electrically connected with the second external electrode 132.

The first internal electrode 121 and the second internal electrode 122 each may include a conductive metal. For example, the conductive metal may include at least one metal selected from the group consisting of, such as Ni, Cu, Ag, Pd, Au, Al, Zr, or an alloy thereof (e.g., Ag—Pd alloy).

The first internal electrode 121 and the second internal electrode 122 may include a dielectric material particle having the same composition as the ceramic material included in the dielectric layer 111.

In general, atomization of a material included in the internal electrode layers 121 and 122 may be required to implement a thin internal electrode layer. As the particle size of the material decreases, the melting point may decrease. A lower melting point may result in a lower heat shrinkage initiation temperature. The melting point of the metal, which is the material of the internal electrode layer, may be lowered to a greater extent than that of ceramic, which is the material of the dielectric layer. In this case, the thinning of the internal electrode layer may further increase the sintering mismatch between the internal electrode layer and the dielectric layer during the sintering of the multi-layered ceramic capacitor. For example, at the point where the sintering mismatch is maximized, the difference between the sintering start temperatures of the dielectric layer and the internal electrode layer may be approximately 500° C. or more. Since the internal electrode layer starts sintering before the dielectric layer, agglomeration of nearby particles may occur, causing balling, and in an area with thin thickness, breakage may occur first, degrading the connectivity of the internal electrode layer.

To solve these problems, a method of adding a covalent material such as barium titanate to the internal electrode layer can be utilized. However, when the amount of the dielectric agent added increases, the film density of the internal electrode layer may decrease, and the dielectric agent may be squeezed out in the dielectric layer direction, which may have the side effect of thickening the thickness of the dielectric layer.

According to some example embodiments of the present disclosure, the internal electrode layers 121 and 122 may include an interface region with the dielectric layer 111 (hereinafter, an interface region of the internal electrode layers 121 and 122).

The interface region of the internal electrode layers 121 and 122 may be defined as a region a depth of 1 μm in the internal direction of the internal electrode layers 121 and 122 from the interface of the dielectric layer 111 and the internal electrode layers 121 and 122.

The interface region of the internal electrode layers 121 and 122 may also be defined as a region where Al or Zr is detected in the elemental concentration profile obtained by performing the STEM-EDS analysis on the L-T cross-section of the multi-layered ceramic capacitor 100.

The interface region of the internal electrode layers 121 and 122 may include Ni, and at least one of Al or Zr. Accordingly, the difference in the sintering start temperature between the dielectric layer 111 and the internal electrode layers 121 and 122 is reduced, shrinkage imbalance is alleviated, and the stability and operation reliability of the MLCC 100 can be improved.

According to some example embodiments, the internal electrode layers 121 and 122 may include the above-described composite particle 50. Accordingly, the sintering start temperature of the internal electrode layers 121 and 122 is increased, and thus cracks due to the difference in shrinkage based on the dielectric layer 111 can be prevented. For example, the internal electrode layers 121 and 122 may be formed by printing a conductive paste containing the composite particle 50.

As some example embodiments, during the manufacture of the MLCC 100, Ni, Al, and/or Zr may diffuse from the composite particle 50 of the internal electrode layers 121 and 122 during firing and be disposed in the interface region of the internal electrode layers 121 and 122 and the dielectric layer 111.

The content of Al or Zr included in the interface region of the internal electrode layers 121 and 122 may be greater than the content of Al or Zr included in the dielectric layer. Accordingly, the difference in the sintering start temperature between the dielectric layer 111 and the internal electrode layers 121 and 122 may be more alleviated, and the structure stability and reliability of the MLCC 100 may be further improved. The content of Al or Zr may refer to the atomic percent of Al or Zr per 100 atom part of Ni.

The content of Al or Zr included in the interface region of the internal electrode layers 121 and 122 may be 0.1 atom percent to 1 atom percent based on 100 atom percent of Ni included in the interface region of the internal electrode layers 121 and 122. In the range, the low resistance characteristics of the internal electrode layers 121 and 122 can be maintained or improved while the stability described above is sufficiently increased.

According to some embodiments, the dielectric layer 111 may include an interface region (hereinafter, referred to as an interface region of the dielectric layer 111) with the internal electrode layers 121 and 122.

The interface region of the dielectric layer 111 may be defined as a region with depth of 1 μm in the internal direction of the dielectric layer 111 from the interface between the dielectric layer 111 and the internal electrode layers 121 and 122.

The interface region of the dielectric layer 111 may include Ni and at least one of Al or Zr. Accordingly, the difference in the sintering start temperature between the dielectric layer 111 and the internal electrode layers 121 and 122 is reduced, shrinkage imbalance is alleviated, and the stability and operation reliability of the MLCC 100 can be improved.

According to some example embodiments, during the manufacture of the MLCC 100, Ni, Al, and/or Zr may diffuse from the composite particle 50 of the internal electrode layers 121 and 122 to the dielectric layer 111 during firing and be disposed in the interface region of the dielectric layer 111.

The content of Al or Zr included in the interface region of the dielectric layer 111 may be 0.1 atom percent to 1 atom percent based on 100 atom percent of Ni included in the interface region of the dielectric layer 111. In the range, the stability described above can be sufficiently increased while insulation between the internal electrodes 121 and 122 through the dielectric layer 111 can be properly maintained.

To confirm/measure the existence of the interface regions and the existence and content of elements contained in the interface regions, the STEM-EDS may be used.

The MLCC 100 may be fixed with epoxy resin and polished with a polishing device such that the L-T cross-section is exposed. The polishing may be performed such that half of the length in the width direction (W-axis direction) is removed. The exposed L-T cross-section may be imaged by STEM to reveal the dielectric layer 111 and internal electrode layers 121 and 122 in the active region, approximately 1 to 6 layers in length. For example, STEM imaging may be performed at an acceleration voltage condition of 200 kV at a magnification of 10 k, which reveals approximately 1 to 6 layers of the dielectric layer 111 and the internal electrode layers 121 and 122. A STEM-EDS analysis image can be obtained by performing EDS mapping analysis on the captured STEM image. Information on the interface regions and Al or Zr contained in the interface regions may be obtained through the STEM-EDS analysis image.

For example, the first internal electrode 121 and the second internal electrode 122 may be formed using a conductive paste including a conductive metal. For example, the conductive paste contains the above-described composite particle 50 and may be printed by screen printing or gravure printing.

According to some example embodiments, an average thickness of the first internal electrode 121 and the second internal electrode 122 may be 0.1 μm to 2 μm. In the range, the resistance can be further reduced by implementing miniaturization and thin film formation of the MLCC 100.

For example, the average thickness of the first internal electrode 121 and the second internal electrode 122 may be measured by the SEM analysis. The SEM analysis may be substantially the same as the average thickness measuring method of the dielectric layer 111 described above.

The capacitor body 110 may be formed by firing a laminate having the plurality of dielectric layers 111 and the internal electrode layers 121 and 122.

Referring to FIG. 5, the first external electrode 131 and the second external electrode 132 may have different polarities.

The first external electrode 131 may be electrically connected to the exposed portion of the first internal electrode 121. For example, the second external electrode 132 may be electrically connected to the exposed portion of the second internal electrode 122.

When a predetermined voltage is applied to the first external electrode 131 and the second external electrode 132, a charge may be accumulated between the first internal electrode 121 and the second internal electrode 122 that face each other. The capacitance of the MLCC 100 may be proportional to an overlap area of the first internal electrode 121 and the second internal electrode 122 on the plane, which overlap each other in the stacking direction (T-axis direction) in the active region.

The first external electrode 131 and the second external electrode 132 may include a first connection portion (not shown) and a second connection portion (not shown), which are respectively disposed in the third side and the fourth side of the capacitor body 110 and connected with the first internal electrode 121 and the second internal electrode 122. The first external electrode 131 and the second external electrode 132 may each include a first band portion (not shown) and a second band portion (not shown) arranged at corners where the third and fourth, first and second, or fifth and sixth sides of the capacitor body 110 meet.

The first band portion and the second band portion may extend from the first and second connection portions to the first side and the second side or parts of the fifth side and the sixth side of the capacitor body 110, respectively. The bonding strength of the first external electrode 131 and the second external electrode 132 may be improved through the first band portion and the second band portion.

The first external electrode 131 and the second external electrode 132 each may include a sintering metal layer that is in contact with the capacitor body 110, a conductive resin layer arranged to cover the sintering metal layer, and a plating layer arranged to cover the conductive resin layer.

The sintering metal layer may include a conductive metal and glass.

The conductive metal may include at least one selected from the group consisting of copper (Cu), nickel (Ni), silver (Ag), palladium (Pd), gold (Au), platinum (Pt), tin (Sn), tungsten (W), titanium (Ti), lead (Pb), an alloy thereof, or a combination thereof, and for example, copper (Cu) may include a copper (Cu) alloy. When the conductive metal contains copper, metals other than copper may be contained in amounts not greater than 5 parts by mole per 100 parts by mole of copper.

The glass may include a composition containing a mixture of oxides, for example, at least one selected from a group consisting of silicon oxide, boron oxide, aluminum oxide, a transition metal oxide, an alkali metal oxide, and an alkaline-earth metal oxide.

The transition metal may include at least one selected from the group consisting of zinc (Zn), titanium (Ti), copper (Cu), vanadium (V), manganese (Mn), iron (Fe), and nickel (Ni). The alkali metal may include at least one selected from a group consisting of lithium (Li), sodium (Na), and potassium (K). The alkaline-earth metal may include at least one selected from a group consisting of magnesium (Mg), calcium (Ca), strontium (Sr), and barium (Ba).

Selectively, the conductive resin layer may be formed on the sintering metal layer, and for example, may be formed in a form that entirely covers the sintering metal layer. In some example embodiments, the first external electrode 131 and the second external electrode 132 may not include the sintering metal layer. In this case, the conductive resin layer may be in direct contact with the capacitor body 110.

The conductive resin layer may extend to the first side and the second side or the fifth side and the sixth side of the capacitor body 110, and a length of a (i.e., band portion) in which the conductive resin layer extends to the first and second sides or the fifth and sixth sides of the capacitor body 110 may be greater than a length of a region (i.e., band portion) in which the sintering metal layer extends to the first and second sides or the fifth and sixth sides of the capacitor body 110. In some example embodiments, the conductive resin layer is formed on the sintering metal layer and may entirely cover the sintering metal layer.

The conductive resin layer may include a resin and a conductive metal.

The resin included in the conductive resin layer may have bonding and impact absorption properties, and may not be particularly limited to a certain resin as long as it can be mixed with conductive metal powder to form a paste, and may include, for example, phenol resin, acrylic resin, silicone resin, epoxy resin, or polyimide resin.

The conductive metal included in the conductive resin layer may have a spherical shape, a flake shape, or a combination thereof. For example, the conductive metal may be in the form of only flakes, only spherical shapes, or a mixture of flake and spherical shapes.

Here, the spherical shape may also include shapes that are not perfect spherical shapes, for example, shapes of which a length ratio (major axis/minor axis) of the major axis and minor axis is 1.45 or less. The flake-shaped powder refers to powder that has a flat and elongated shape, and is not particularly limited, but for example, the length ratio of the major axis to the minor axis (major axis/minor axis) may be 1.95 or more.

The first external electrode 131 and the second external electrode 132 may further include a plating layer disposed outer side of the conductive resin layer.

The plating layer may contain at least one selected from the group consisting of nickel (Ni), copper (Cu), tin (Sn), palladium (Pd), platinum (Pt), gold (Au), silver (Ag), tungsten (W), titanium (Ti), or lead (Pb) alone or as an alloy thereof. For example, the plating layer may be a nickel (Ni) plating layer or a tin (Sn) plating layer, and may be in a form in which a nickel (Ni) plating layer and a tin (Sn) plating layer are sequentially laminated, or may be in a form in which a tin (Sn) plating layer, a nickel (Ni) plating layer, and a tin (Sn) plating layer are sequentially laminated. In addition, the plating layer may include a plurality of nickel (Ni) plating layers and/or a plurality of tin (Sn) plating layers.

Through the plating layer, the substrate mountability, structural reliability, external durability, and heat resistance of the MLCC 100 can be further improved, and the equivalent series resistance (ESR) can be further reduced.

Hereinafter, a manufacturing method of the MLCC 100 according to some example embodiments will be described.

A manufacturing method of the MLCC 100 may include manufacturing the capacitor body 110 including the dielectric layer 111 and the internal electrodes 121 and 122, and forming the external electrodes 131 and 132 at the outer side of the capacitor body 110.

In the manufacturing process of the capacitor body 110, a paste for dielectric material that becomes the dielectric layer 111 after firing and a conductive paste that becomes the internal electrode layers 121 and 122 after firing may be prepared.

A plastic powder may be obtained by uniformly mixing and drying a dielectric powder through wet mixing and the like, and then performing heat treatment under predetermined conditions. The paste for the dielectric material may be manufactured by adding an organic vehicle or an aqueous vehicle to the plastic powder and heating and mixing the mixture.

A dielectric green sheet may be obtained by forming the paste for the dielectric material into a sheet using a technique such as the doctor blade method. For example, the paste for the dielectric material may contain additives selected from various dispersants, a plasticizer, a dielectric material, a secondary component compound, and/or glass.

A conductive paste for an internal electrode may be prepared by kneading the conductive powder made of a conductive metal or its alloy with a binder or a solvent.

The conductive paste for the internal electrode may contain indium (In).

In some example embodiments of the present disclosure, the conductive paste for the internal electrode may include the above-described composite particle 50. Accordingly, the difference in the sintering start temperature of the internal electrode layers 121 and 122 and the sintering start temperature of the dielectric layer 111 is alleviated, and thus crack occurrence during the sintering process of the MLCC 100 can be suppressed and stability and reliability can be improved.

According to another example embodiments, Ni, Al, and/or Zr of the composite particle 50 included in the conductive paste for the internal electrode may diffuse into the dielectric layer 111 by sintering and be disposed at the above-described interface region. Accordingly, the difference in shrinkage start temperature between the internal electrode layers 121 and 122 and the dielectric layer 111 can be reduced, thereby improving the structural reliability of the MLCC 100.

The conductive paste for the internal electrode may be applied to the dielectric green sheet surface in a predetermined pattern using various printing methods such as screen printing or a transfer method. The dielectric green sheet laminate may be obtained by stacking multiple layers of dielectric green sheets having an internal electrode pattern and applying pressure in the lamination direction. The dielectric green sheet and the internal electrode pattern may be laminated on upper and lower surfaces of the dielectric green sheet laminate in the lamination direction such that the dielectric green sheet is positioned.

Selectively, the dielectric green sheet laminate may be cut to predetermined dimensions by dicing or the like.

The dielectric green sheet laminate may be solidified and dried to remove a plasticizer and the like as needed, and then barrel polishing may be carried out using a horizontal centrifugal barrel machine and the like after the solidifying and drying. In the barrel polishing, the dielectric green sheet laminate is placed into a barrel container together with media and polishing liquid, and rotational motion or vibration is applied to the barrel container to polish unnecessary parts such as burrs generated during cutting. For example, after the barrel polishing, the dielectric green sheet laminate may be washed with a cleaning solution such as water and dried.

The capacitor body 110 may be obtained by debindering and firing the dielectric green sheet laminate.

The condition of the debinder treatment may be appropriately adjusted depending on a primary component composition of the dielectric layer or a primary component composition of the internal electrode. For example, a temperature increase speed during debinder treatment may be about 5° C./hour to 300° C./hour, a support temperature may be about 180° C. to about 400° C., and a temperature holding time may be about 0.5 hour to about 24 hours. The debinder atmosphere may be air or a reducing atmosphere.

The condition of the firing treatment may be appropriately adjusted depending on the primary component composition of the dielectric layer or the primary component composition of the internal electrode. For example, a temperature during firing may be about 1200° C. to about 1350° C., or about 1220° C. to about 1300° C., and the time may be about 0.5 hour to about 8 hours, or 1 hour to 3 hours. The sintering atmosphere may be a reduction atmosphere, for example, a humidifying atmosphere of mixed gas of nitrogen gas N₂ and hydrogen gas H₂. When the internal electrodes 121 and 122 include nickel (Ni) or a nickel (Ni) alloy, the oxygen partial pressure in the firing atmosphere may be about 1.0×10⁻¹⁴ MPa to about 1.0×10⁻¹⁰ MPa.

After the firing treatment, annealing may be performed as needed. The annealing is a treatment to re-oxidize the dielectric layer, and annealing may be performed when the firing treatment is performed in a reducing atmosphere. The conditions of the annealing treatment may also be appropriately adjusted depending on the composition of the primary component of the dielectric layer. For example, the temperature during annealing may be about 950° C. to about 1150° C., the time may be about 0 hours to about 20 hours, and the heating speed may be about 50° C./hour to about 500° C./hour. The annealing atmosphere may be a humidifying nitrogen gas N₂ atmosphere, and the oxygen partial pressure may be 1.0×10⁻9 MPa to 1.0×10⁻⁵ MPa.

In the debinder treatment, firing treatment, or annealing treatment, for humidifying nitrogen gas or mixed gas, a wetter, and the like may be used, and in this case, the water temperature may be 5° C. to 75° C. The debindering, firing, and annealing treatments may be performed sequentially or independently.

Selectively, a surface treatment such as sandblasting, laser irradiation, or barrel polishing may be performed on a third side and a fourth side of the obtained capacitor body 110. Through such a surface treatment, ends of the first internal electrode 121 and the second internal electrode 122 may be exposed to the uppermost surfaces of the third and fourth sides. Accordingly, the electrical junction between the first external electrode 131 and the second external electrode 132 and the first internal electrode 121 and the second internal electrode 122 is improved, and an alloy portion can be easily formed.

The external electrodes 131 and 132 may be formed on one side of the manufactured capacitor body 110.

For example, a sintering metal layer may be formed by applying a paste for forming a sintering metal layer and then sintering.

The paste for forming the sintering metal layer may include the above-described conductive metal and glass. In addition, the paste for forming the sintering metal layer may selectively include a binder, solvent, dispersant, plasticizer, oxide powder, and the like. The binder may include, for example, ethylcellulose, acryl, butyral (butyral), and the solvent may include, for example, an organic solvent or an aqueous solvent, such as terpineol, butylcarbitol, alcohol, methylethylketone, acetone, toluene.

A method for applying the paste for forming the sintering metal layer to the outer surface of the capacitor body 110 include various printing methods such as a dip method, screen printing, a coating method using a dispenser, and a spray method using a spray.

The paste for forming the sintering metal layer is applied to at least the third side and the fourth side of the capacitor body 110, and may be selectively applied to a portion of the first side, the second side, the fifth side, or the sixth side where band portions of the first external electrode and the second external electrode are formed.

Afterwards, the capacitor body 110 to which the paste for forming the sintering metal layer has been applied is dried, and the sintering metal layer may be formed by sintering at a temperature of 700° C. to 1000° C. for 0.1 to 3 hours.

Selectively, a paste for forming a conductive resin layer may be applied to the outer surface of the obtained capacitor body 110 and then cured to form a conductive resin layer.

The paste for forming the conductive resin layer may include a resin and, selectively a conductive metal or a non-conductive filler. The description of the conductive metal and resin is the same as described above, and therefore a repetitive description is omitted. In addition, the paste for forming the conductive resin layer may selectively include a binder, a solvent, a dispersant, a plasticizer, oxide powder, and the like. The binder may include, for example, ethylcellulose, acryl, butyral (butyral), and the solvent may include organic solvents or aqueous solvents such as terpineol, butylcarbitol, alcohol, methylethylketone, acetone, toluene, and the like.

For example, the conductive resin layer may be formed by dipping the capacitor body 110 in the conductive resin layer forming paste and then curing it, printing the conductive resin layer forming paste on the surface of the capacitor body 110 using a screen printing method or gravure printing method, or applying the conductive resin layer forming paste on the surface of the capacitor body 110 and then curing it.

A plating layer may be formed on the outer side of the conductive resin layer.

For example, the plating layer may be formed by a plating method, or may be formed by sputter or electric deposition.

Hereinafter, a specific example of the present disclosure will be described. However, examples described below are only intended to specifically illustrate or describe the present disclosure.

### Example 1

### (Manufacturing Composite Particle)

A first solution was formed by injecting and mixing AlCl₃·6H₂O 12.35 g to an ethanol solvent.

A second solution was formed by injecting Ni nanoparticle 100 g to the first solution. Accordingly, a composite particle contained 3 parts by mole of Al for 100 parts by mole of Ni.

The second solution was dispersed using a bath sonicator and a tip sonicator to form a third solution. Tip sonication was performed at a frequency of 20 kHz and an electric power of 40 W for 2 h.

The third solution was applied to a hot plate maintained at 160° C. and dried until the ethanol solvent was volatilized to produce a composite particle including a nickel core and an Al oxide shell.

### (Manufacturing Pellet)

The composite particle manufactured by the above-described method was compressed to manufacture a cylindrical pellet having a diameter of about 0.5 mm and a height of about 2.0 mm to 2.5 mm.

### (Manufacturing Multi-Layered Ceramic Capacitor)

A dielectric green sheet was manufactured using barium titanate (BaTiO₃) as a primary component powder, and then a conductive paste layer containing the composite particle described above was printed on a surface of the dielectric green sheet, and the dielectric green sheets (width×length×height=3.2 mm×2.5 mm×2.5 mm) on which the conductive paste layer was formed were laminated and pressed to manufacture a dielectric green sheet laminate. The dielectric green sheet laminate was fired at a temperature of 400° C. or less in a nitrogen atmosphere through a calcination process, and then fired at a temperature of 1300° C. or less and a hydrogen concentration of 1.0% H₂ or less to manufacture a capacitor body.

Next, a multi-layered ceramic capacitor was manufactured through processes such as forming external electrodes and plating.

### Example 2

A composite particle, a pellet, and a multi-layered ceramic capacitor were manufactured using the same method as in Example 1, except that 11.92 g of ZrCl₄ was added instead of AlCl₃·6H₂O to an ethanol solvent (3 parts by mole of Zr per 100 parts by mole of Ni).

### Example 3

A composite particle, a pellet, and a multi-layered ceramic capacitor were manufactured using the same method as in Example 1, except that 0.0041 g of AlCl₃·6H₂O was added to an ethanol solvent.

### Example 4

A composite particle, a pellet, and a multi-layered ceramic capacitor were manufactured using the same method as in Example 1, except that 20.58 g of AlCl₃·6H₂O was added to an ethanol solvent.

### Comparative Example 1

A composite particle, a pellet, and a multi-layered ceramic capacitor were manufactured using the same method as in Example 1, except that a Ni nano particle was used instead of the composite particle.

### Comparative Example 2

A composite particle, a pellet, and a multi-layered ceramic capacitor were manufactured using the same method as in Example 1, except that 0.0021 g of AlCl₃·6H₂O was added to an ethanol solvent.

### Comparative Example 3

A composite particle, a pellet, and a multi-layered ceramic capacitor were manufactured using the same method as in Example 1, except that 22.64 g (or wt %) of AlCl₃·6H₂O was added to an ethanol solvent.

### Evaluation 1: Structure Analysis (SEM, SEM-EDS, TEM) of Composite Particle

An SEM analysis image and a TEM analysis image were obtained for the composite particles of the above-described Examples 1 and 2 and the Ni nanoparticles of Comparative Example 1.

The SEM analysis was measured under accelerating voltage conditions of 0.01 kV to 30 kV.

An SEM-EDS analysis image was obtained by performing EDS mapping analysis on the SEM analysis image.

The TEM analysis was measured at 10 k magnification and an accelerating voltage of 200 kV.

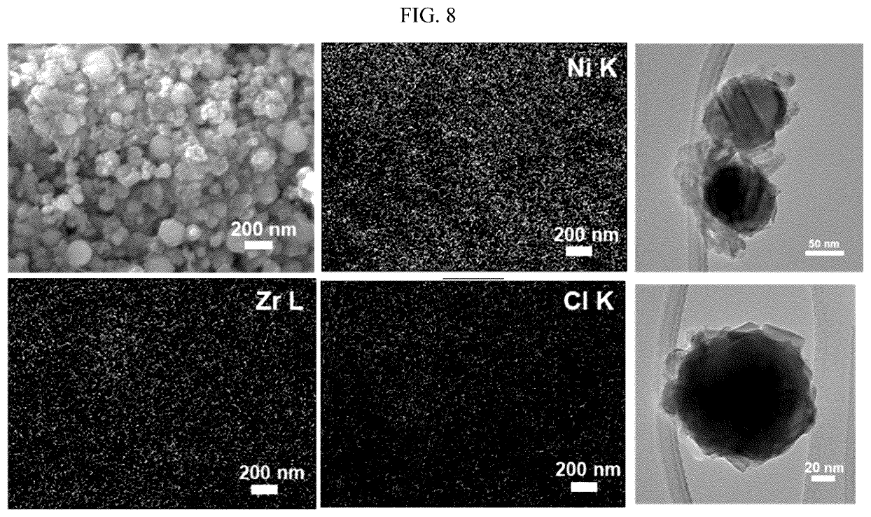

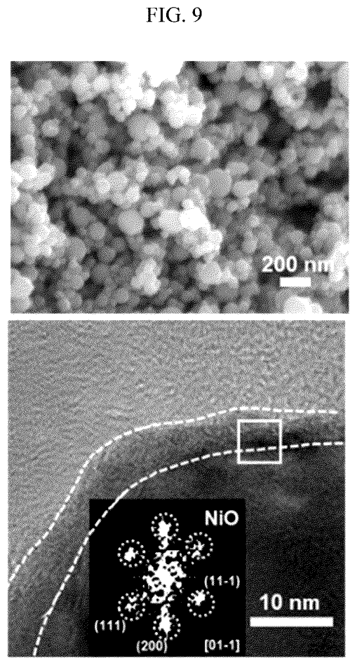

FIG. 7 shows SEM, SEM-EDS, and TEM analysis images of composite particles according to Example 1. FIG. 8 shows SEM, SEM-EDS, and TEM analysis images of composite particles according to Example 2. FIG. 9 shows SEM, SEM-EDS, and TEM analysis images of composite particles according to Comparative Example 1.

Referring to FIG. 7 to FIG. 9, the composite particles of Examples 1 and 2 have a shell including an Al compound and a Zr compound disposed on the Ni core, respectively, but the shell was not observed in the composite particles of Comparative Example 1.

### Evaluation 2: Composition Analysis (ICP-AES) of Composite Particle

The inductively coupled plasma-atomic emission spectroscopy (ICP-AES) analysis was performed on the composite particles of Examples 1 to 4, the composite particles of Comparative Examples 2 and 3, and the Ni nanoparticles of Comparative Example 1.

Specifically, a sample was prepared by dissolving a predetermined weight of composite particles in acid, decomposing them using a microwave, diluting them with distilled water, and then filtering them. The sample was introduced into the ICP-AES device using a nebulizer. Argon (Ar) gas was injected into the ICP-AES device while the plasma state was maintained during analysis, and the content of Al relative to the number of moles of Ni in the composite particle (Example 1) and the content of Zr relative to the number of mols of Ni in the composite particle (Example 2) were measured.

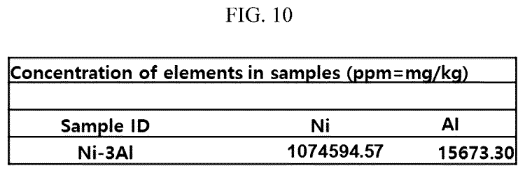

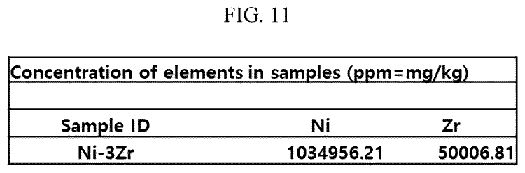

FIG. 10 shows an ICP-AES analysis result of the composite particle according to Example 1. FIG. 11 shows an ICP-AES analysis result of the composite particle according to Example 2.

Referring to FIG. 10 and FIG. 11, the Al content of the composite particle of Example 1 is about 3 mol % relative to the number of mols of Ni, and the Zr content of the composite particle of Example 2 is about 3 mol % relative to the number of moles of Ni.

### Evaluation 3: Thermomechanical Analysis (TMA)

Thermomechanical Analysis (TMA) was performed on the pellets of Examples 1 and 2 and Comparative Example 1.

Specifically, the pellet was placed into a TMA device, and the temperature was increased at a rate of 10° C./min in the range of 25° C. to 1000° C. in an argon (Ar) atmosphere, and a thickness change rate of the pellet was measured. A load applied to the pellet was set to 0.2 N.

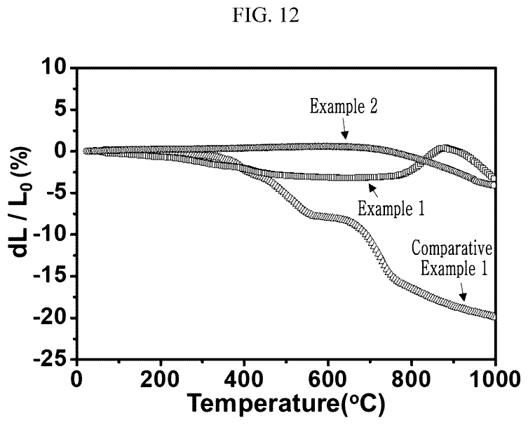

FIG. 12 is a TMA graph showing the volume change according to the sintering temperature of the composite particle pellets according to Examples 1 and 2 and Comparative Example 1. In FIG. 12, L₀ denotes an initial thickness of the pellet and dL denotes a change in thickness of the pellet.

Referring to FIG. 12, shrinkage of the pellet began at about 400° C. in Comparative Example 1, shrinkage of the pellet began at about 900° C. in Example 1, and shrinkage of the pellet began at about 800° C. in Example 2. Therefore, in the composite particles of the Examples which includes the shell containing Al or Zr, the sintering start temperatures were about 400° C. or more higher than that of Comparative Example 1.

### Evaluation 4: Relative Density Analysis

For the pellets of Examples 1 and 2 and Comparative Example 1, sintering was performed at 600° C., 700° C., 800° C., 900° C., and 1000° C. for 5 minutes each, and the relative density (density after sintering/density before sintering, %) at each temperature was measured. The relative density was measured using the Archimedes method.

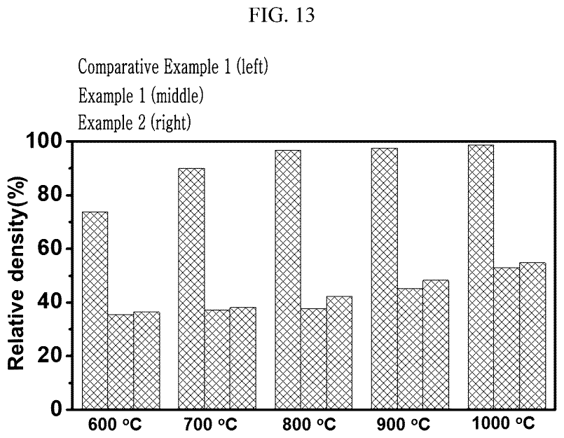

FIG. 13 is a graph that shows a change in density according to the sintering temperature of the composite particle pellets according to Examples 1 and 2 and Comparative Example 1.

Referring to FIG. 13, significant shrinkage of the pellet occurred at 600° C. in Comparative Example 1, whereas shrinkage (increase in density) of the pellet began at 900° C. and 800° C. in Examples 1 and 2, respectively. After sintering at 1000° C., the densities of the pellets of Examples 1 and 2 were relatively smaller than those of the pellets of Comparative Example 1. Therefore, the shrinkage due to sintering was relatively reduced in the pellets according to Examples 1 and 2 compared to the pellet according to Comparative Example 1.

### Evaluation 5: XRD Analysis

For the pellets of Examples 1 and 2 and Comparative Example 1, X-ray diffraction (XRD) analysis was performed to observe a phase behavior.

The XRD analysis was performed under conditions of K-Alpha1 wavelength of 1.540598 Å, a driving voltage of 45 kV, and a scan range of 10° to 120°.

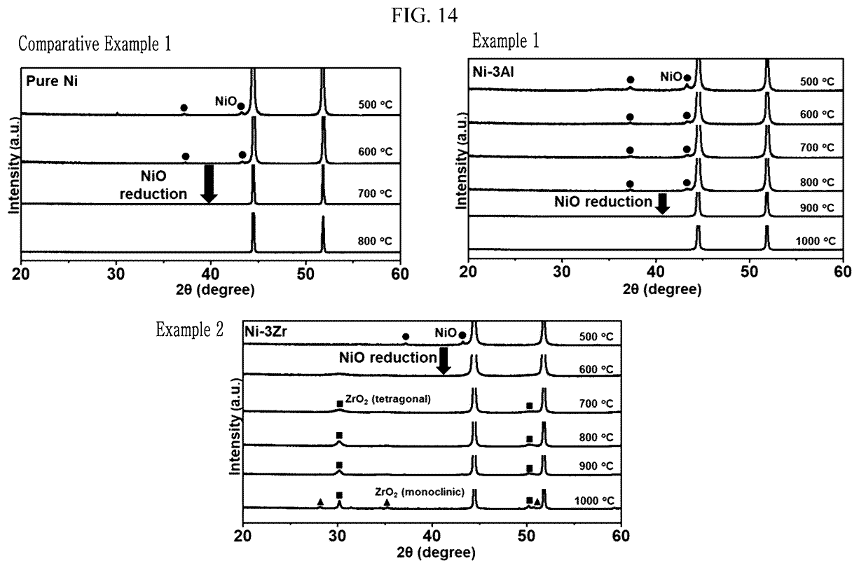

FIG. 14 is an XRD graph of the composite particle pellet according to Examples 1 and 2 and Comparative Example 1.

Referring to FIG. 14, NiO positioned on the core was reduced above 600° C. in Comparative Example 1.

In Example 1, NiO was reduced above 800° C., increasing a reduction temperature by more than 200° C. compared to Comparative Example 1. Accordingly, the structure of the composite particle pellet was maintained stably compared to Comparative Example 1.

In Example 2, NiO was reduced at 500° C., but ZrO₂ was formed on the core from 700° C., suppressing sintering of the pellet.

### Evaluation 6: SEM Analysis According to Sintering Temperature

For each of the pellets of Examples 1 and 2 and Comparative Example 1, sintering was performed at 600° C., 700° C., 800° C., 900° C., and 1000° C. for 5 minutes each, and then the pellets were cut in the length direction through the center point to expose a cross-section.

The SEM analysis image of the cross-section according to the sintering temperature was obtained using the same SEM analysis method as in Evaluation 1.

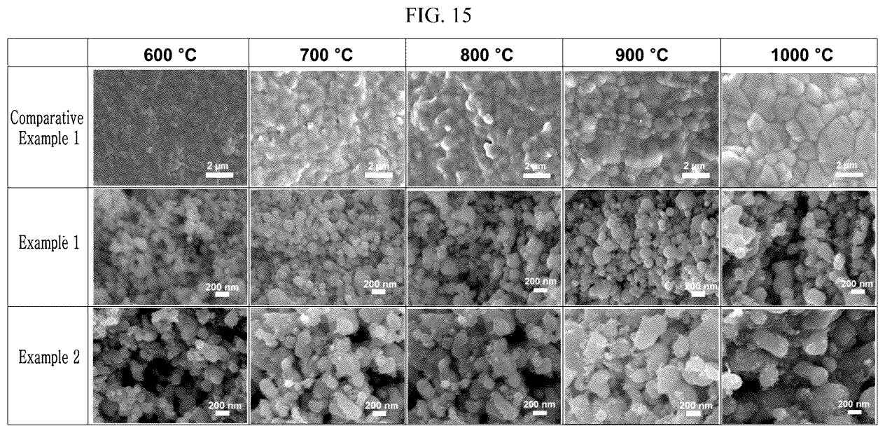

FIG. 15 shows SEM analysis images of composite particle pellets according to sintering temperatures according to Examples 1 and 2 and Comparative Example 1.

Referring to FIG. 15, in Comparative Example 1, Ni nanoparticles were agglomerated starting at 600° C., particle coarsening and grain growth occurred at 700° C., and particles were densified at 800° C.

In Example 1, the initial morphology of the composite particles was maintained up to 900° C., and agglomeration of some particles was observed at 1000° C.

In Example 2, the initial morphology of the composite particles was maintained up to 800° C., and agglomeration of some particles was observed at above 900° C.

### Evaluation 7: TEM Analysis

For the pellets of Examples 1 and 2, after sintering at 600° C. and 800° C. for 5 minutes each, the pellets were cut in the length direction through the center point to expose the cross-section.

The TEM analysis image of the cross-section according to the sintering temperature was obtained using the same TEM analysis method as in Evaluation 1.

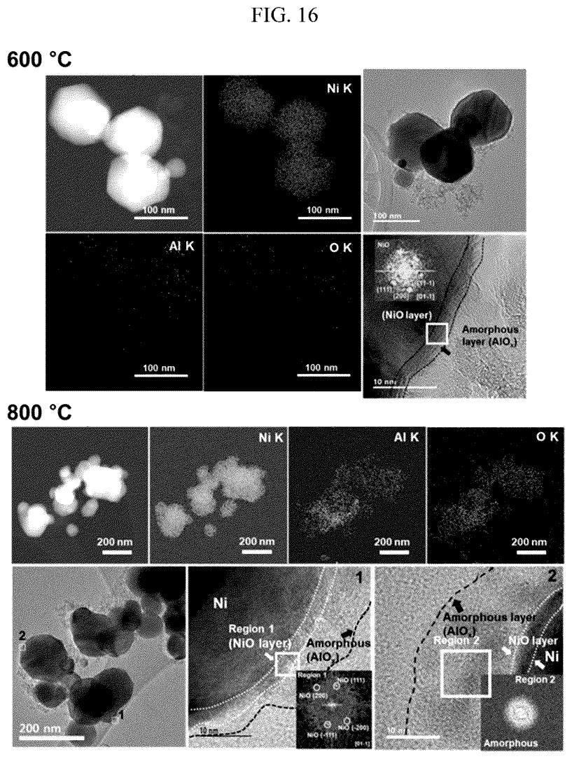

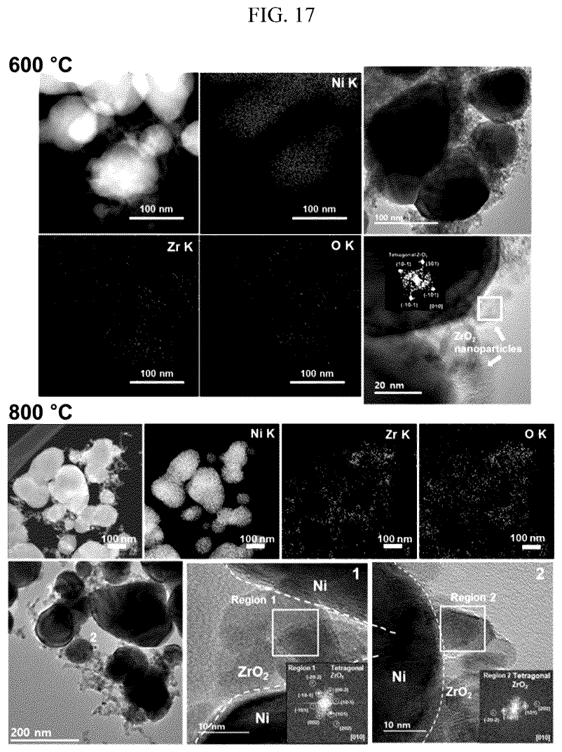

FIG. 16 shows TEM analysis images of the composite particle pellet according to the sintering temperature according to Example 1. FIG. 17 shows TEM analysis images of the composite particle pellet according to the sintering temperature according to Example 2.

Referring to FIG. 16, an AlOₓ amorphous film was formed relatively uniformly on the Ni core, which increased the sintering temperature of the pellet.

Referring to FIG. 17, ZrO₂ was formed on the Ni core, and the particle enlargement and densification of Ni were suppressed due to the Zener pinning effect of the ZrO₂. For example, ZrO₂ of several tens of nanometers in size can inhibit the grain interface movement of Ni nanoparticles, thereby suppressing particle enlargement and densification.

### Evaluation 8: STEM-EDS Analysis of Interface Region

The multi-layered ceramic capacitor of the Examples 1 and 2 were laid down horizontally, and an area around the multi-layered ceramic capacitor was fixed with epoxy resin.

The multi-layered ceramic capacitor was polished using a polishing machine such that a cross-section cut perpendicular to the width direction (W-axis direction) and in the length direction (L-axis direction) and the lamination direction (T-axis direction) was exposed from the center of the width direction (W-axis direction).

The exposed cross-section was photographed using a scanning transmission electron microscope (STEM) to obtain a STEM image.

EDS mapping analysis was performed on the STEM image to obtain an STEM-EDS analysis image.

The STEM imaging was performed at 10K magnification and 200 kV acceleration voltage conditions on regions where at least one dielectric layer and one internal electrode layer were visible.

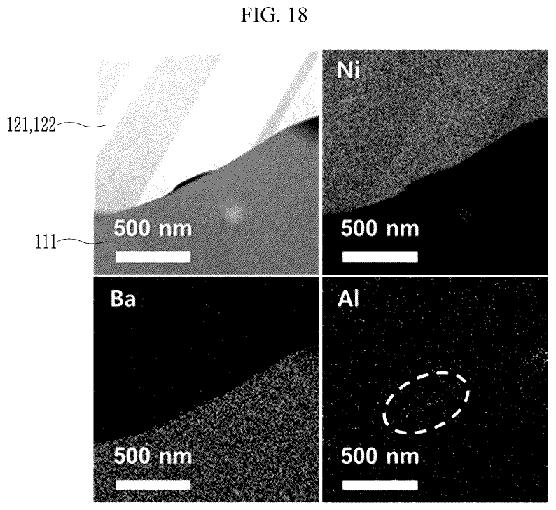

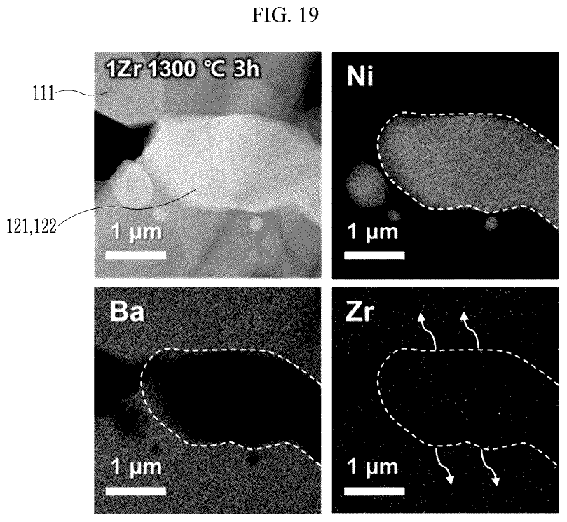

FIG. 18 are STEM-EDS analysis images of the cross-section of the multi-layered ceramic capacitor according to Example 1. FIG. 19 are STEM-EDS analysis images of the cross-section of the multi-layered ceramic capacitor according to Example 2.

Referring to FIG. 18, Ni and Al were diffused into the interface region of internal electrode layers 121 and 122. The Al content was measured from 0.1 atom percent to 1 atom percent per 100 atom percent of Ni.

Referring to FIG. 19, Ni and Zr were diffused into the interface region of the dielectric layer 111. The Zr content was measured from 100 atom part to 0.1 atom percent per 100 atom percent of Ni.

### Evaluation 9: Connectivity of Internal Electrode Layer (SEM Analysis)

The multi-layered ceramic capacitors of Examples 1 and 2 and Comparative Example 1 were laid down horizontally, and the periphery of the multi-layered ceramic capacitors were fixed with epoxy resin.

The multi-layered ceramic capacitor was polished using a polishing machine such that a cross-section cut perpendicular to the width direction (W-axis direction) and in the length direction (L-axis direction) and the lamination direction (T-axis direction) was exposed from the center of the width direction (W-axis direction).

For the exposed cross-section, SEM analysis images were obtained using the same method as the SEM analysis method of Evaluation 1 for regions where more than 8 internal electrode layers existed.

From the SEM analysis image, the connectivity of the internal electrode layer was calculated using Equation 1 below.

$$Connectivity ( \% ) of internal electrode layer = ( sum of lengths exluding disonnected parts in a plurality of internal electrode layer / sum of entire lengths of the plurality of internal electrode layers ) \times 100 \qquad [ Equation 1 ]$$

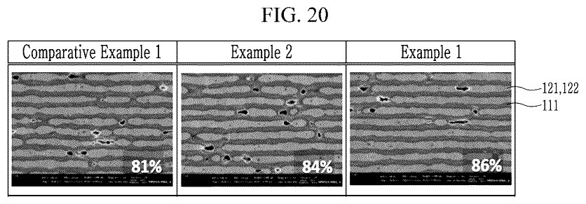

FIG. 20 is SEM analysis images that show the connectivity of the multi-layered ceramic capacitors according to Examples 1 and 2 and Comparative Example 1.

Referring to FIG. 20, the connectivity in Examples 1 and 2 is relatively improved compared to Comparative Example 1.

### Evaluation 10: Capacity

For the multi-layered ceramic capacitors according to the examples and the comparative examples, the capacity was measured under a frequency of 1 kHz and a voltage of 0.5 V.

A predetermined reference capacity was set, and the measured capacity was divided by the reference capacity and multiplied by 100 to evaluate it as a percentage.

### Evaluation 11: MTTF Measurement

For the multi-layered ceramic capacitors according to the examples and the comparative examples, a mean time to failure (MTTF) was measured. Specifically, the MTTF was measured for 48 hours at a temperature of 125° C. and a voltage of 9.45 V.

The elements contained in the shell of the examples and comparative examples, the contents of Al or Zr versus the number of moles of Ni, capacity, connectivity, and MTTF are shown in the following Table 1.

TABLE 1

| | | Al or Zr content | | | |
|---|---|---|---|---|---|
| | Element | (mol %) to | Capac- | Connec- | |
| | included | number of moles | ity | tivity | MTTF |
| | in shell | of Ni | (%) | (%) | (hr) |
| Example 1 | Al | 3 | 101.9 | 86 | 33.92 |
| Example 2 | Zr | 3 | 99.4 | 84 | 27.22 |
| Example 3 | Al | 0.001 | 98.8 | 85 | 25.24 |
| Example 4 | Al | 5.0 | 98.5 | 83 | 26.77 |
| Comparative | — | — | 94.4 | 81 | 20.07 |
| Example 1 | | | | | |
| Comparative | Al | 0.0005 | 94.2 | 80 | 20.23 |
| Example 2 | | | | | |
| Comparative | Al | 5.5 | 90.1 | 77 | 12.34 |
| Example 3 | | | | | |

Referring to Table 1, in the examples where the content of Al or Zr is from 0.001 parts by mole to 5.0 parts by mole relative to 100 parts by mole of Ni, the capacity characteristics, connectivity, and reliability are improved compared to the comparative examples.

While this invention has been described in connection with what is presently considered to be practical exemplary embodiments, it is to be understood that the invention is not limited to the disclosed exemplary embodiments. On the contrary, it is intended to cover various modifications and equivalent arrangements included within the spirit and scope of the appended claims.

What is claimed is:

1. A composite particle comprising:
a core containing nickel (Ni); and
a shell disposed on the core and including a compound containing at least one of aluminum (Al) or zirconium (Zr),
wherein a content of Al and/or Zr is from 0.001 parts by mole to 5.0 parts by mole based on 100 parts by mole of Ni in the composite particle.

2. The composite particle of claim 1, wherein the compound contains at least one selected from the group consisting of an Al oxide and a Zr oxide.

3. The composite particle of claim 2, wherein the Al oxide in an amorphous structure, and the Zr oxide is in a crystalline structure.

4. The composite particle of claim 1, wherein the compound is located on at least a portion of a surface of the core.

5. The composite particle of claim 1, wherein the core includes a Ni nanoparticle.

6. The composite particle of claim 1, wherein the core is a region in which a Ni content is 95 mol % or more with respect to a total amount of elements included in the composite particle, and
the shell is a region in which the Ni content is less than 5 mol % with respect to the total amount of elements included in the composite particle and includes Al or Zr.

7. The composite particle of claim 1, further comprising a middle layer located between the core and the shell, and the middle layer containing a Ni oxide.

8. The composite particle of claim 7, wherein the Ni oxide contains NiO.

9. The composite particle of claim 7, wherein the middle layer is a region in which a Ni content is 5 mol % or more and less than 95 mol % with respect to the total amount of elements included in the composite particle.

10. A multi-layered ceramic capacitor comprising:
a capacitor body comprising a dielectric layer and an internal electrode; and
an external electrode located at an outer side of the capacitor body,
wherein the internal electrode layer comprises an interface region with the dielectric layer,
the interface region of the internal electrode layer contains Ni and at least one of Al or Zr, and
the multi-layered ceramic capacitor uses the composite particle of claim 1.

11. The multi-layered ceramic capacitor of claim 10, wherein:
the interface region of the internal electrode layer is a region from an interface of the dielectric layer and the internal electrode layer to a depth of 1 μm in the inward direction of the internal electrode layer.

12. The multi-layered ceramic capacitor of claim 10, wherein:
the content of Al or Zr in the interface region of the internal electrode layer is 0.1 atom percent to 1 atom percent based on 100 atom percent of Ni in the interface region of the internal electrode layer.

13. The multi-layered ceramic capacitor of claim 10, wherein:
Al or Zr diffuses from the composite particle and exists in the interface region of the internal electrode layer and the dielectric layer.

14. The multi-layered ceramic capacitor of claim 13, wherein:
the content of Al or Zr in the interface region of the internal electrode layer is greater than the content of Al or Zr in the dielectric layer.

15. The multi-layered ceramic capacitor of claim 10, wherein:
the dielectric layer comprises an interface region with the internal electrode layer, the interface region of the dielectric layer includes Ni and at least one of Al or Zr, and
the interface region of the dielectric layer is defined as a region from the interface of the dielectric layer and the internal electrode layer to a depth of 1 μm in the inward direction of the dielectric layer.

16. The multi-layered ceramic capacitor of claim 15, wherein:
the content of Al or Zr in the interface region of the dielectric layer is 0.1 atom percent to 1 atom percent based on 100 atom percent of Ni in the interface region of the dielectric layer.

17. A manufacturing method of a composite particle, comprising:
forming a first solution by injecting at least one selected from a group consisting of an Al precursor and a Zr precursor to a solvent;
forming a second solution by injecting Ni power to the first solution;
forming a third solution by dispersing the second solution using a sonication method; and
obtaining a composite particle by drying the third solution,
wherein the composite particle comprises a core containing Ni and a shell disposed on the core and comprising a compound that contains at least one of Al or Zr, and
a content of Al or Zr of the composite particle is from 0.001 parts by mole to 5.0 parts by mole based on 100 parts by mole of Ni.

18. The manufacturing method of the composite particle of claim 17, wherein:
the Al precursor contains Al chloride and the Zr precursor contains Zr chloride.

19. The manufacturing method of the composite particle of claim 17, wherein:
the drying comprises applying the third solution on a hot plate and volatilizing the solvent.
